(19) United States
(12) Patent Application Publication
(10) Pub. No.: US 2002/0192996 A1
(43) Pub. Date: Dec. 19, 2002

(54) Electrical connector for flat cable having a strain relief function

(76) Inventors: Charles A. Kozel, McHenry, IL (US); John T. Scheitz, Barrington, IL (US)

Correspondence Address: Bar of the State of Illinois, 55 East Monroe Street, Suite 4200, Chicago, IL, 60603-5803, US

(21) Appl. No.: 09/880,273

(22) Filed: Jun. 13, 2001

(51) Int. Cl. H01R 4/24; H01R 11/20; H01R 4/26

(52) U.S. Cl. 439/404

(57) ABSTRACT

A connector for a flat cable which reduces strain on the cable. The connector includes a first portion attached to a second portion. The second portion has a top surface and a bottom surface. A flat cable may have a segment secured to a bottom surface of the second portion. The flat cable may be further secured between the second portion and first portion while the second portion and first portion are attached. A remaining segment of the flat cable may be positioned through an opening extending from the bottom surface of the second portion to the top surface. As a result, a stress or force exerted on the remaining segment of the flat cable may be diverted away from the cable and into the connector.

### BACKGROUND OF THE INVENTION

1. Field of the Invention

The present invention generally relates to a flat cable accessory. More specifically, the present invention relates to a connector designed to reduce strain on a flat cable.

2. Discussion of the Background

It is generally known to provide a circuit. Generally, a circuit can have terminals. A first set of terminals can be connected to an apparatus which performs a function. A second set of terminals can be connected to a power source for the apparatus, such as, for example, a battery. The power is distributed between the terminals by a cable.

It is in the interest of manufacturers to provide a cable which is an efficient conductor. To this end, manufacturers must decide on the type of structure the cable can have, whether coaxial, flat or other possible designs. Additionally, manufacturers must choose the type of conducting material within the cable such as gold, silver, copper or other material.

It is also in the interest of manufacturers to provide a cable that is durable. To this end, manufacturers must decide which kind of material they will use to insulate the conductor. The chosen material must be able to withstand any stress associated with the apparatus within which the cable is implemented. Often in an apparatus, a cable can become damaged due to stress applied to the cable from being pulled or bent, for example. Therefore, manufacturers desire a cable that has increased flexibility.

As a result, manufacturers have designed flat cable. A flat cable is a cable which has a width that is greater than its thickness. The flat cable can have a plurality of conductors positioned in a parallel manner. The conductors are flat and are encompassed by insulating material such as plastic, rubber, or the like.

One manner of connecting the conductors of a flat cable to a terminal is by positioning the flat cable across the terminal such that an end of the terminal protrudes through the cable. In this position, the end is also in contact with the conductors.

However, when stress is applied to a flat cable, the conductors can be moved away from the ends of the terminals. Or, the stress can damage the flat cable itself, also leading to an inefficient connection.

A need, therefore, exists for a connecting device for a connection between a flat cable and a terminal which prevents deterioration of the same due to stress on the flat cable.

### SUMMARY OF THE INVENTION

The present invention provides a connector for a flat cable which reduces strain on the cable. The connector includes a first portion having protruding edges along opposite sides of the first portion. The connector further includes a second portion attached to the first portion. The second portion may have an interior edge which is positioned adjacent to the protruding edges of the first portion to attach the second portion to the first portion. The second portion has a top surface and a bottom surface. A flat cable has a segment secured to a bottom surface of the second portion. The flat cable is further secured between the second portion and first portion when the second portion and first portion are attached. A remaining segment of the flat cable may be positioned through an opening extending from the bottom surface of the second portion to the top surface. As a result, a stress or force exerted on the remaining segment of the flat cable is diverted away from the cable and into the components of the connector.

To this end, in an embodiment of the present invention, a connector is provided. The connector has a body having a first opening and a second opening. A first segment of a cable can be positioned within the first opening. Also, a second segment of the cable can be positioned within the second opening. As a result, a force exerted on the second segment of the cable is diverted into the connector.

In another embodiment of the present invention, a connector is provided. The connector has a top surface and a bottom surface. The connector also has a means for securing a cable to the bottom surface. In addition, the connector has an opening extending from the top surface to the bottom surface, the opening being sized to receive a segment of the cable. A stress exerted on the cable is then transferred into the connector.

In another embodiment of the present invention, a cable and connector assembly is provided. The system includes a cable and a connector. In addition, the cable has a first segment secured between a first portion and a second portion of the connector. The cable further includes a second segment extending from an opening in the second portion of the connector. The opening is positioned such that a force exerted towards the second segment of the cable is directed toward the second portion of the connector.

In still another embodiment of the present invention, a method is provided for relieving stress on a cable. The method has a step of providing a connector having a top surface and a bottom surface; providing an opening within the connector, the opening extending between the top surface and the bottom surface; securing a first segment of the cable to the bottom surface; and positioning a second segment of the cable within the opening such that a stress exerted on the second segment of the cable is directed toward the connector.

It is, therefore, an advantage of the present invention to provide a connector structure that reduces strain on an electrical connection caused by stress to a flat cable.

Another advantage of the present invention is to provide a connector structure that reduces strain on the conductors of a cable which may be caused by stress to a flat cable.

Another advantage of the present invention is to provide a connector structure that increases the longevity of an electrical connection.

Yet another advantage of the present invention is to provide a connector structure that increases the efficiency of an electrical connection.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a partial section view of an embodiment of the present invention prior to assembly;

FIG. 2 is a side view of the first portion of FIG. 1 in an embodiment of the present invention;

FIG. 3 is a top view of the first portion of FIG. 1 in an embodiment of the present invention;

FIG. 4 is a bottom view of the first portion of FIG. 1 in an embodiment of the present invention;

FIG. 5 is a side view of the second portion of FIG. 1 in an embodiment of the present invention;

FIG. 6 is a top view of the second portion of FIG. 1 in an embodiment of the present invention;

FIG. 7 is a bottom view of the second portion of FIG. 1 in an embodiment of the present invention;

FIG. 8 is a partial section view of the connector of FIG. 1 in a partially assembled state in an embodiment of the present invention;

FIG. 9 is a partial section view of the connector of FIG. 1 in a fully assembled state in an embodiment of the present invention; and

FIG. 10 is a side view of the connector of FIG. 1 in a fully assembled state in an embodiment of the present invention.

### DETAILED DESCRIPTION OF THE PRESENTLY PREFERRED EMBODIMENTS

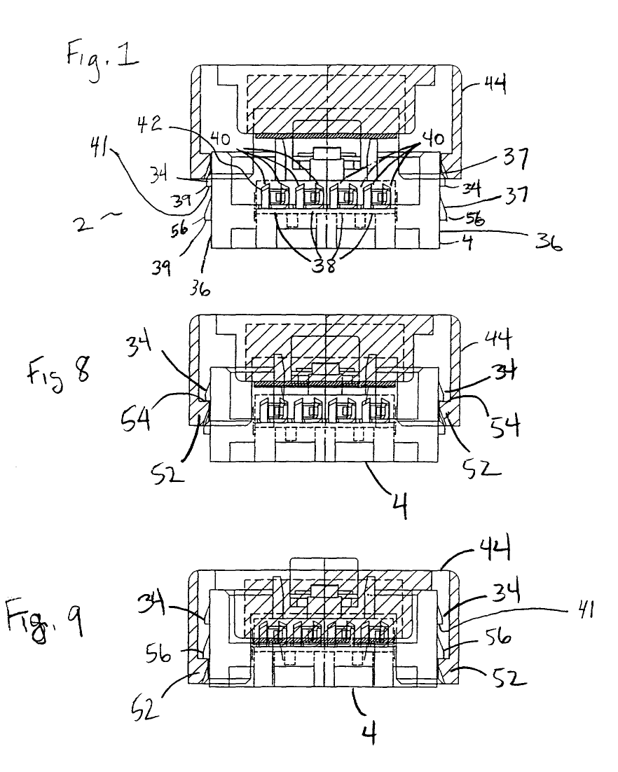

FIG. 1 illustrates an embodiment of a connector 2 of the present invention. The connector 2 includes a first portion 4. In an embodiment, the first portion 4 is constructed of plastic; however, the first portion 4 can be constructed of other electrically insulative materials.

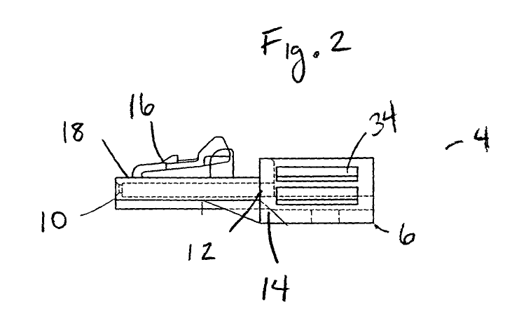

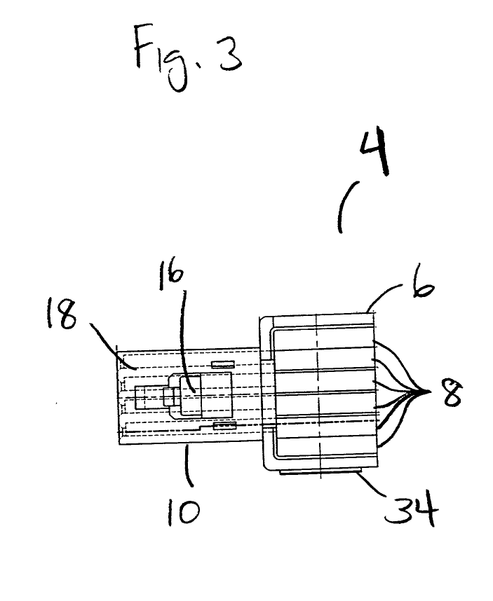

FIG. 2 illustrates a side view of the first portion 4. The first portion 4 has a base 6. The base 6 may be rectangular in shape, as illustrated in FIG. 3. The first portion 4 also has a set of ribs 8 formed within an interior floor of the base 6. A ledge 10 is attached to the base 6, preferably near the center 12 of an end 14 of the base 6. The ledge 10 has a width greater than its thickness. A snap arm 16 is attached to a top surface 18 of the ledge 10. The snap arm 16 enables the connector to interlock with various circuit components. The ledge 10 also has a set of inclined ridges 22 on a bottom surface 24 of the ledge 10 as illustrated in FIG. 4. The inclined ridges 22 extend to the center 26 of the bottom surface 28 of the base 6. A second set of ridges 30 extends from an opposite end 32 of the bottom surface 28 of the base 6. Preferably, the first set of ridges 22 are greater in length than the second set of ridges 30.

In addition, the first portion 4 may have protruding edges 34 along at least one side 36 of the base 6. Preferably, the protruding edges 34 are along opposite sides 36 of the first portion 4. The protruding edges 34 have an incline 37 with respect to the sides 36 of the first portion 4. Further, the incline 37 ends at a point 39, leaving a base 6 perpendicular to the sides 36 of the first portion 4.

The first portion 4 also has a set of terminals 38 extending from the base 6 of the first portion 4 within an interior of the first portion 4. Preferably, there are four terminals along the base 6 of the first portion 4, however, any number of terminals 38 can be used. The terminals 38 have knife edges 40 at a top end 42 of the terminal 38. The knife edges 40 are angled to provide a sharp edge for a flat cable that may be positioned onto the terminal 38. The knife edge 40 of the terminal 38 can be constructed from metal or conductive metallic engineering material. The flat cable is pressed down over the terminals such that the knife edges 40 of the terminals 38 protrude through a first insulation layer of the flat cable. The knife edges 40 then protrude through the conducting material within the flat cable as well as an outer insulation layer of the flat cable. The terminals 38 are then in contact with the conductors located within the flat cable, thus providing an electrical connection. Moreover, the flat cable is surrounding a terminal 38. Because the terminal 38 protrudes through both insulation layers of the flat cable, the flat cable is securely locked within the area of the terminals 38.

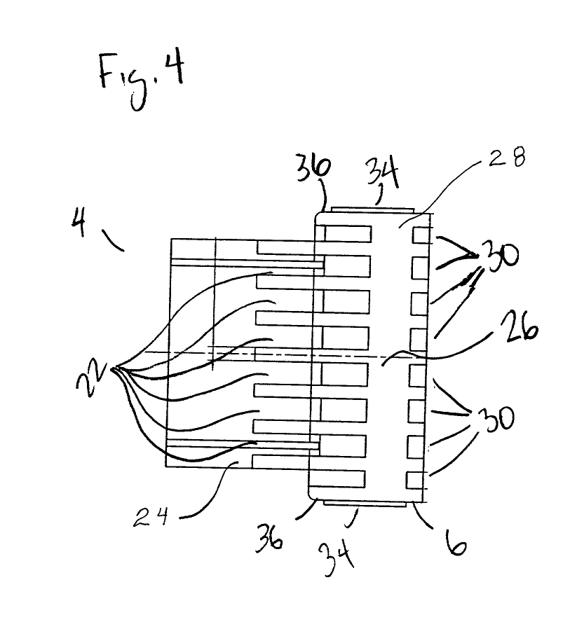

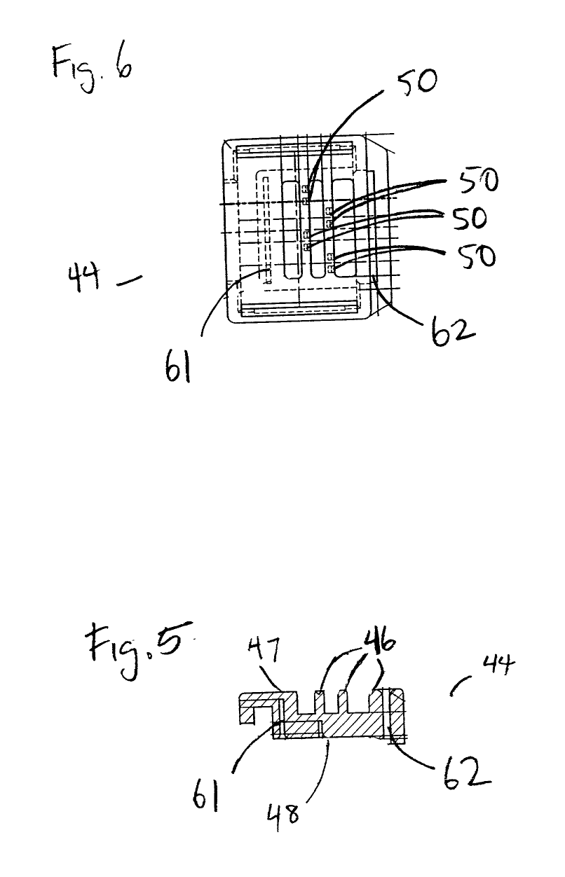

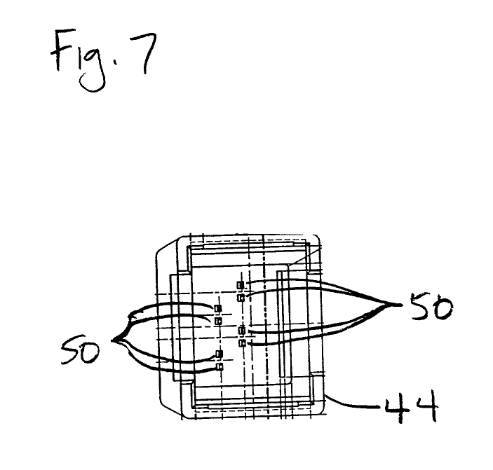

The connector 2 also has a second portion 44 which can be attached to the first portion 4. FIG. 5 illustrates a side view of the second portion 44. The second portion 44 can be formed from plastic, metal, or the like. The second portion 44 has ridges 46 within a top surface 47 to enable the connector 2 to be more easily packaged with other circuit components within an apparatus. FIG. 6 illustrates a top view of the second portion 44. The bottom surface 48 of the second portion 44 contains openings 50 for terminals 38 as illustrated in FIG. 7. Preferably, there are four sets of openings 50 for terminals 38 to fit within, however, any number of openings 50 may be used. Typically, the number of openings 50 correspond to the number of terminals 38.

FIG. 8 illustrates the second portion 44 positioned over the first set of protruding edges 34. The second portion 44 may be positioned over the first portion 4 manually or, the second portion 44 may be mechanically positioned. The second portion 44 has an interior edge 52 which is placed over the protruding edges 34 of the first portion 4. An end 54 of the interior edge 52 comes in contact with the incline 37 as the second portion 44 is placed over the first portion 4. The incline 37 enables the end 54 to slide across the incline 37 and eventually move past the point 39 where the incline 37 ends. The interior edge 52 then engages the base 41 of the protruding edge 34. In this intermediate assembly position, the cable 3 is associated with the connector. In operation, an assembler can use two hands to assemble the first portion 4 and the second portion 44 to the intermediate assembly position. In this state, the first portion 4 and the second portion 44 of the connector 2 are stable and the intermediate assembly can be held and manipulated with one hand. The assembler can then use their free hand to associate the cable 3 with the intermediately assembled connector 2.

FIG. 9 illustrates the connector 2 whereby the interior edge 52 of the second portion 44 is positioned adjacent to the second set of protruding edges 56 of the first portion 4. The second portion 44 is positioned over the second set of protruding edges 56 in a manner similar to the positioning of the second portion 44 over the first set of protruding edges 34. While in this state, the protruding edges 56 provide resistance against the interior edge 52 of the second portion 44 to prevent the second portion 44 from disengaging from the first portion 4. In this position, the first portion 4 and the second portion 44 are fully engaged with each other, and the cable 3 and connector 2 are in a final, assembled state.

In another embodiment, the connector 2 is integrally formed. The connector has a top portion similar in shape to the second portion 44 having a top surface and a bottom surface. The top surface has an opening extending to the bottom surface for insertion of a cable. Further, the connector 2 has a bottom portion similar in shape to the first portion 4 having a top surface and a bottom surface. The top surface of the bottom portion contains terminals which protrude through a cable positioned within the connector 2. The cable is secured to the connector 2 by the terminals. A remainder segment of the cable extends through the opening in the top portion. Stress exerted on the remainder segment is diverted into the connector 2.

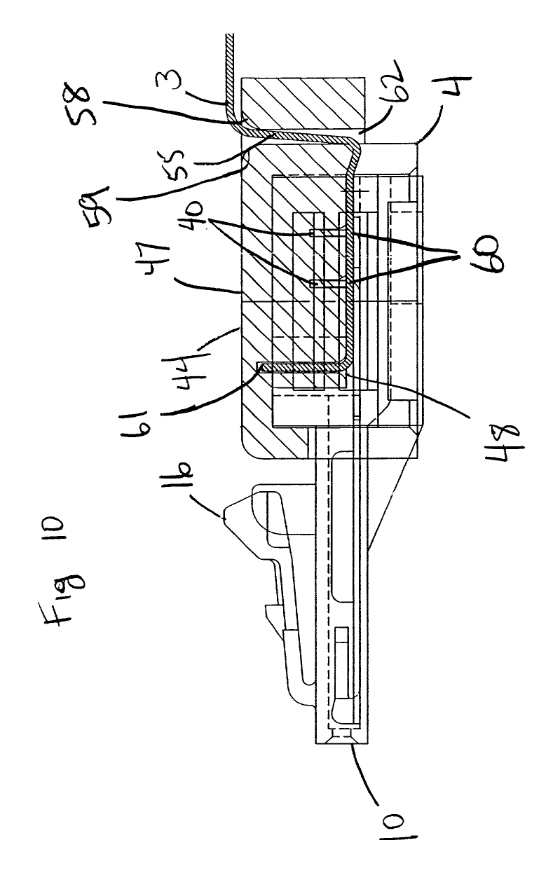

FIG. 10 illustrates a side view of the connector 2 wherein the flat cable 3 is positioned between the second portion 44 and the first portion 4 while the second portion 44 and the first portion 4 are attached. The present invention enables the flat cable 3 to direct stress away from the flat cable 3 and into the components of the connector 2. The second portion 44 has an opening 61 which can receive a segment of flat cable 3. A leftover end 55 of the flat cable 3, after the flat cable 3 is positioned along the knife edges 40, is placed within the opening 61. The second portion 44 also has a second opening 62 allowing the insertion of the flat cable 3 into the connector 2. The opening 62 may extend in a non-parallel direction from the top surface 47 to the bottom surface 48. In an embodiment, the opening 62 extends perpendicular to the top surface 47. The second opening 62 is shaped such that the flat cable must be bent to be positioned within the second portion 44. The bent portion of the flat cable is then in contact with an upper edge 58 of the second portion 44. By configuring the flat cable into this shape, the connector 2 diverts any stress on the flat cable away from the contact point 60. In fact, the stress is directed toward the second portion 44 and first portion 4. As a result, the electrical connection is maintained.

It is appreciated, that, by securing the flat cable 3 to the bottom surface 48 of the second portion 44 and directing the leftover end 55 of the cable 3 through the opening 62, stress or force exerted on the cable 3 is diverted to the second portion 44 of the connector 2. Moreover, because the second portion 44 and the first portion 4 are attached, a portion of the stress is diverted into the first portion 4. If the stress is in a direction parallel to the cable in FIG. 9, the stress will be directed into the upper edge 58 of the second portion 44. If the stress is exerted in a direction perpendicular to the top surface 47, by, for example, pulling the flat cable 3 in an upward direction, the force may be diverted into an edge 59 opposite the upper edge 58.

It is further appreciated that other types of cable may be used with the present invention. For example, if a coaxial cable is used, the bottom surface 48 of the second portion could contain a means for receiving a coaxial terminal from a coaxial cable. The coaxial cable would then be secured to the bottom surface 48 of the second portion. The first portion 4 would still be in contact between the interior edge 52 and the protruding edges 34. The remainder of the cable could be positioned within the opening 62. Again, any stress on the cable would be diverted to the second portion 44, first portion 4, or both. Thus, the contact point between the cable terminal and the means for receiving the terminal would be relieved of a portion of stress exerted on the remainder of the cable. Accordingly, the present invention can be modified for a variety of cables, with each embodiment providing a means for securing the cable to a bottom surface 48 of the second portion 44 as well as an opening 62 extending from the top surface 47 of the second portion 44 to the bottom surface 48, the opening sized to receive a segment of the cable.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that all such changes and modifications be second portioned by the appended claims.

1. A connector for a cable comprising:
a body having a first opening and a second opening, wherein a first segment of a cable can be positioned within the first opening, and further wherein a second segment of the cable can be positioned within the second opening, wherein a force exerted on the second segment of the cable is diverted into the body of the connector.

2. The connector of claim 1 wherein the cable is a flat cable.

3. The connector of claim 1 wherein the body includes a first portion having at least one set of protruding edges positioned on a side of the first portion.

4. The connector of claim 3 wherein an interior edge of a second portion of the body is positioned adjacent to the protruding edges, and further wherein the protruding edges provide resistance against the interior edge of the second portion to prevent the second portion from disengaging from the first portion.

5. The connector of claim 1 wherein the body includes a second portion having openings capable of receiving terminals.

6. The connector of claim 5 wherein the cable is secured to the second portion by the terminals.

7. The connector of claim 1 wherein the body includes a first portion and a second portion which are removably attached.

8. The connector of claim 1 wherein the body includes a first portion and a second portion which are integrally attached.

9. A connector comprising:
a top surface and a bottom surface;
means for securing a cable to the bottom surface; and
an opening extending from the top surface to the bottom surface, the opening sized to receive a segment of the cable, and wherein
a stress exerted on the cable is transferred into the connector.

10. The connector of claim 9 wherein the means for securing the cable to the bottom surface of the connector includes openings for receiving terminals, the terminals extending through a segment of the cable.

11. The connector of claim 9 having a second top surface and a second bottom surface attached to the bottom surface.

12. The connector of claim 11 wherein a set of terminals extend from the second top surface.

13. The connector of claim 9, further including a second opening between the top surface and bottom surface, the second opening capable of receiving an end of the cable.

14. The connector of claim 9 wherein the cable is a flat cable.

15. A cable and connector assembly comprising:
the connector; and
a first segment secured between a first portion and a second portion of the connector, the cable further including a second segment extending from an opening in the second portion, the opening positioned such that a force exerted towards the second segment of the cable is directed toward the connector.

16. The cable and connector assembly of claim 15 wherein the first portion and second portion are removably attached.

17. The cable and connector assembly of claim 15 wherein the first portion and second portion are integrally attached.

18. The cable and connector assembly of claim 15 wherein the second portion includes a top surface and a bottom surface, wherein the opening extends from the top surface to the bottom surface.

19. The cable and connector assembly of claim 15 wherein the first portion includes a set of protruding edges.

20. The cable and connector assembly of claim 19 wherein the second portion includes an interior edge which can be positioned adjacent to the set of protruding edges to attach the second portion to the first portion.

21. The cable and connector assembly of claim 15 wherein the first segment is secured between the second portion and first portion by a set of terminals extending from the first portion into a set of openings within the second portion.

22. A method of relieving stress on a cable, the method comprising the steps of:
providing a connector having a top surface and a bottom surface;
providing an opening within the connector, the opening extending between the top surface and the bottom surface;
securing a first segment of the cable to the bottom surface; and
positioning a second segment of the cable within the opening such that a stress exerted on the second segment of the cable is directed toward the connector.
